(19) United States
(12) Patent Application Publication
(10) Pub. No.: US 2022/0080711 A1
(43) Pub. Date: Mar. 17, 2022

(54) ANTIMICROBIAL COMPOSITE

(71) Applicant: Canco Hungary Kit, Gyor (HU)

(72) Inventor: Bernd Elfering, Ahaus (DE)

(73) Assignee: Canco Hungary Kit, Gyor (HU)

(21) Appl. No.: 17/023,446

(22) Filed: Sep. 17, 2020

(51) Int. Cl. B32B 27/12; B32B 5/02; B32B 27/32

(52) U.S. Cl. CPC B32B 27/12; B32B 5/024; B32B 27/32; B32B 2250/05; B32B 2250/42; B32B 2307/414; B32B 2260/04

(57) ABSTRACT

Provided is an antimicrobial composite comprising a top layer having a polypropylene film impregnated with elemental silver, a silver compound, or a mixture thereof, the top layer having a thickness between 33 μm and 77 μm, and the top layer having a mass between 30.36 and 70.84 grams per square meter; a second layer beneath the top layer, the second layer having a standard twill weave translucent material, having a thickness between 0.09 mm and 0.21 mm, and having a mass between 81.6 and 190.4 grams per square meter; a third layer beneath the second layer, the third layer having a polypropylene film, having a thickness between 0.012 mm and 0.028 mm, and having a mass between 11.04 and 25.76 grams per square meter; and wherein the antimicrobial composite has a specific antimicrobial activity of at least 3.

### FIELD

The present patent application relates to composite materials, forming same, and their use. More particularly the present patent application relates composite materials having antimicrobial properties, forming same, and their applications.

### BACKGROUND

Composite materials are common and desirable in a variety of applications. In some applications, the presence of microbes, bacteria and viruses, on the surface or ingrained within the composite material are undesirable. Composite materials and forming composite materials that are inherently antimicrobial is of interest. Composite materials that are inherently antimicrobial that are relatively inexpensive, or relatively low in weight, or are relatively strong, or have a high specific strength, or are more adaptable to a variety of requirements, also continue to be of interest.

Accordingly, those skilled in the art continue with research and development efforts in the field of antimicrobial composite materials and forming same.

### SUMMARY

Disclosed are antimicrobial composites and ways to make and use same.

In one example, the antimicrobial composite comprises a top layer having a polypropylene film impregnated with elemental silver, a silver compound, or a mixture thereof, the top layer having a thickness between 33 μm and 77 μm, and the top layer having a mass between 30.36 and 70.84 grams per square meter; a second layer beneath the top layer, the second layer having a standard twill weave translucent material, having a thickness between 0.09 mm and 0.21 mm, and having a mass between 81.6 and 190.4 grams per square meter; a third layer beneath the second layer, the third layer having a polypropylene film, having a thickness between 0.012 mm and 0.028 mm, and having a mass between 11.04 and 25.76 grams per square meter; and wherein the antimicrobial composite has a specific antimicrobial activity of at least 3.

In another example, the antimicrobial composite comprises a top layer having a first polypropylene film with a copper layer of elemental copper or a copper compound or a mixture thereof vapor deposited thereon, the first polypropylene film having a thickness between 39 μm and 91 μm, the copper layer having a thickness between 30 μm and 70 μm, and the top layer having an average mass between 36 grams per square meter and 84 grams per square meter; a second layer beneath and in contact with the top layer, the second layer having a standard twill weave translucent material, having a thickness between 0.09 mm and 0.21 mm, and having an average mass of 81.6 grams per square meter and 190.4 grams per square meter; a third layer beneath and in contact with the second layer, the third layer having a second polypropylene film, having a thickness between 0.012 mm and 0.028 mm, and having an average mass of between 11.04 grams per square meter and 25.76 grams per square meter; and wherein the antimicrobial composite has a specific antiviral activity with respect to bacteriophage MS2 of at least 5.4.

Other examples of the disclosed antimicrobial composites and method for forming same and method for using same will become apparent from the following detailed description, the accompanying drawings and the appended claims.

### BRIEF DESCRIPTION OF THE DRAWINGS

FIG. 1 is a sectional view of one of the disclosed antimicrobial composites.

FIG. 2 is a sectional view of another of the disclosed antimicrobial composites.

### DETAILED DESCRIPTION

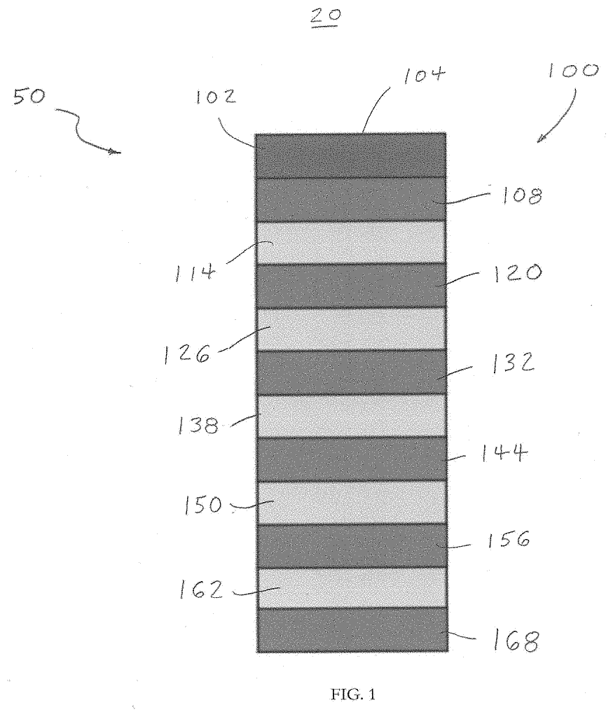

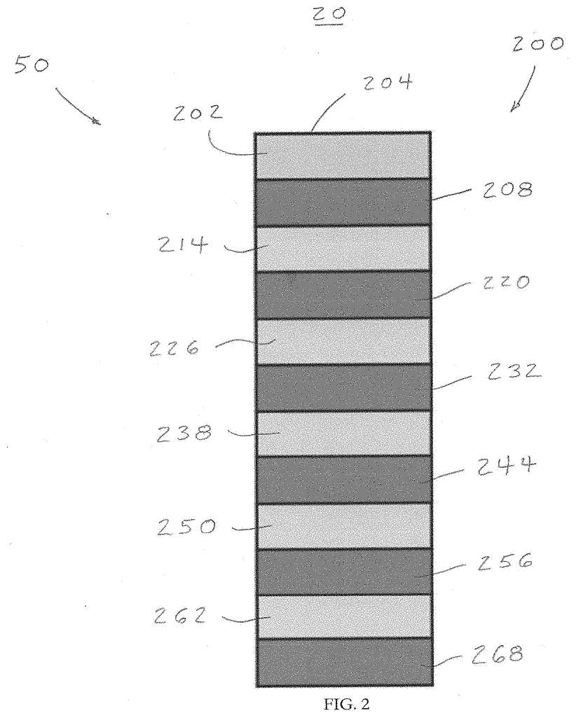

Referring now to FIGS. 1 and 2, disclosed are antimicrobial composites 50. In one aspect, an antimicrobial composite 50 is an antibacterial composite 100. In another aspect, an antimicrobial composite 50 is an antiviral composite 200.

Referring now to FIG. 1, shown is one non-limiting aspect of an antibacterial composite 100. In the aspect shown in FIG. 1, the antibacterial composite 100 comprises a multitude of layers. In the aspect shown in FIG. 1, the antibacterial composite 100 has a total thickness of 1.055 mm. This latter recited thickness is optional and the thickness may deviate from that latter recited figure by 10%, by 20%, or by 40%. In the aspect shown in FIG. 1, the antibacterial composite 100 has an average mass of 958.6 grams per square meter. This latter recited mass per square meter is optional and the mass per square meter may deviate from that latter recited figure by 10%, by 20%, or by 40%.

In the aspect shown in FIG. 1, the antibacterial composite 100 comprises a first layer 102. The first layer 102 is the top-most layer, and has a top surface 104 exposed to the environment 20. In this aspect, the first layer 102 comprises a polypropylene film impregnated with elemental silver or a silver compound or a mixture thereof. In the non-limiting aspect shown in FIG. 1, the polypropylene film impregnated with elemental silver or a silver compound or a mixture thereof is 55 μm thick. This latter recited thickness is optional and the thickness may deviate from that latter recited figure by 10%, by 20%, or by 40%. In the non-limiting aspect shown in FIG. 1, the polypropylene film may optionally be polypropylene film impregnated with an additive based on silver and zinc ions with a polypropylene carrier. In one non-limiting aspect, an additive based on silver and zinc ions with a polypropylene carrier is 3% Argusan AM 1085 polypropylene silver batch. In the non-limiting aspect shown in FIG. 1, the first layer 102 has an average mass of 50.6 grams per square meter. This latter recited mass per square meter is optional and the mass per square meter may deviate from that latter recited figure by 10%, by 20%, or by 40%.

In the aspect shown in FIG. 1, the antibacterial composite 100 comprises a second layer 108. The second layer 108 is optional. In the non-limiting aspect shown, the second layer 108 is directly beneath and in contact with the first layer 102, but this latter condition is optional and it is contemplated that one or more intermediate sublayers [not shown] may be between the first layer 102 and the second layer 108. In the non-limiting aspect shown in FIG. 1, the second layer 108 comprises a standard twill weave translucent material. In the non-limiting aspect shown in FIG. 1, the second layer 108 is 0.15 mm thick. This latter recited thickness is optional and the thickness may deviate from that latter recited figure by 10%, by 20%, or by 40%. In the non-limiting aspect shown in FIG. 1, the second layer 108 has an average mass of 136 grams per square meter. This latter recited mass per square meter is optional and the mass per square meter may deviate from that latter recited figure by 10%, by 20%, or by 40%.

In the aspect shown in FIG. 1, the antibacterial composite 100 comprises a third layer 114. The third layer 114 is optional. In the non-limiting aspect shown, the third layer 114 is directly beneath and in contact with the second layer 108, but this latter condition is optional and it is contemplated that one or more intermediate sublayers [not shown] may be between the second layer 108 and the third layer 114. In the non-limiting aspect shown in FIG. 1, the third layer 114 comprises a polypropylene film. In the non-limiting aspect shown in FIG. 1, the third layer 114 is 0.02 mm thick. This latter recited thickness is optional and the thickness may deviate from that latter recited figure by 10%, by 20%, or by 40%. In the non-limiting aspect shown in FIG. 1, the third layer 114 has an average mass of 18.4 grams per square meter. This latter recited mass per square meter is optional and the mass per square meter may deviate from that latter recited figure by 10%, by 20%, or by 40%.

In the aspect shown in FIG. 1, the antibacterial composite 100 comprises a fourth layer 120. The fourth layer 120 is optional. In the non-limiting aspect shown, the fourth layer 120 is directly beneath and in contact with the third layer 114, but this latter condition is optional and it is contemplated that one or more intermediate sublayers [not shown] may be between the third layer 114 and the fourth layer 120. In the non-limiting aspect shown in FIG. 1, the fourth layer 120 comprises a standard twill weave translucent material. In the non-limiting aspect shown in FIG. 1, the fourth layer 120 is 0.15 mm thick. This latter recited thickness is optional and the thickness may deviate from that latter recited figure by 10%, by 20%, or by 40%. In the non-limiting aspect shown in FIG. 1, the fourth layer 120 has an average mass of 136 grams per square meter. This latter recited mass per square meter is optional and the mass per square meter may deviate from that latter recited figure by 10%, by 20%, or by 40%.

In the aspect shown in FIG. 1, the antibacterial composite 100 comprises a fifth layer 126. The fifth layer 126 is optional. In the non-limiting aspect shown, the fifth layer 126 is directly beneath and in contact with the fourth layer 120, but this latter condition is optional and it is contemplated that one or more intermediate sublayers [not shown] may be between the fourth layer 120 and the fifth layer 126. In the non-limiting aspect shown in FIG. 1, the fifth layer 126 comprises a polypropylene film. In the non-limiting aspect shown in FIG. 1, the fifth layer 126 is 0.02 mm thick. This latter recited thickness is optional and the thickness may deviate from that latter recited figure by 10%, by 20%, or by 40%. In the non-limiting aspect shown in FIG. 1, the fifth layer 126 has an average mass of 18.4 grams per square meter. This latter recited mass per square meter is optional and the mass per square meter may deviate from that latter recited figure by 10%, by 20%, or by 40%.

In the aspect shown in FIG. 1, the antibacterial composite 100 comprises a sixth layer 132. The sixth layer 132 is optional. In the non-limiting aspect shown, the sixth layer 132 is directly beneath and in contact with the fifth layer 126, but this latter condition is optional and it is contemplated that one or more intermediate sublayers [not shown] may be between the fifth layer 126 and the sixth layer 132. In the non-limiting aspect shown in FIG. 1, the sixth layer 132 comprises a standard twill weave translucent material. In the non-limiting aspect shown in FIG. 1, the sixth layer 132 is 0.15 mm thick. This latter recited thickness is optional and the thickness may deviate from that latter recited figure by 10%, by 20%, or by 40%. In the non-limiting aspect shown in FIG. 1, the sixth layer 132 has an average mass of 136 grams per square meter. This latter recited mass per square meter is optional and the mass per square meter may deviate from that latter recited figure by 10%, by 20%, or by 40%.

In the aspect shown in FIG. 1, the antibacterial composite 100 comprises a seventh layer 138. The seventh layer 138 is optional. In the non-limiting aspect shown, the seventh layer 138 is directly beneath and in contact with the sixth layer 132, but this latter condition is optional and it is contemplated that one or more intermediate sublayers [not shown] may be between the sixth layer 132 and the seventh layer 138. In the non-limiting aspect shown in FIG. 1, the seventh layer 138 comprises a polypropylene film. In the non-limiting aspect shown in FIG. 1, the seventh layer 138 is 0.02 mm thick. This latter recited thickness is optional and the thickness may deviate from that latter recited figure by 10%, by 20%, or by 40%. In the non-limiting aspect shown in FIG. 1, the seventh layer 138 has an average mass of 18.4 grams per square meter. This latter recited mass per square meter is optional and the mass per square meter may deviate from that latter recited figure by 10%, by 20%, or by 40%.

In the aspect shown in FIG. 1, the antibacterial composite 100 comprises an eighth layer 144. The eighth layer 144 is optional. In the non-limiting aspect shown, the eighth layer 144 is directly beneath and in contact with the seventh layer 138, but this latter condition is optional and it is contemplated that one or more intermediate sublayers [not shown] may be between the seventh layer 138 and the eighth layer 144. In the non-limiting aspect shown in FIG. 1, the eighth layer 144 comprises a standard twill weave translucent material. In the non-limiting aspect shown in FIG. 1, the eighth layer 144 is 0.15 mm thick. This latter recited thickness is optional and the thickness may deviate from that latter recited figure by 10%, by 20%, or by 40%. In the non-limiting aspect shown in FIG. 1, the eighth layer 144 has an average mass of 136 grams per square meter. This latter recited mass per square meter is optional and the mass per square meter may deviate from that latter recited figure by 10%, by 20%, or by 40%.

In the aspect shown in FIG. 1, the antibacterial composite 100 comprises a ninth layer 150. The ninth layer 150 is optional. In the non-limiting aspect shown, the ninth layer 150 is directly beneath and in contact with the eighth layer 144, but this latter condition is optional and it is contemplated that one or more intermediate sublayers [not shown] may be between the eighth layer 144 and the ninth layer 150. In the non-limiting aspect shown in FIG. 1, the ninth layer 150 comprises a polypropylene film. In the non-limiting aspect shown in FIG. 1, the ninth layer 150 is 0.02 mm thick. This latter recited thickness is optional and the thickness may deviate from that latter recited figure by 10%, by 20%, or by 40%. In the non-limiting aspect shown in FIG. 1, the ninth layer 150 has an average mass of 18.4 grams per square meter. This latter recited mass per square meter is optional and the mass per square meter may deviate from that latter recited figure by 10%, by 20%, or by 40%.

In the aspect shown in FIG. 1, the antibacterial composite 100 comprises a tenth layer 156. The tenth layer 156 is optional. In the non-limiting aspect shown, the tenth layer 156 is directly beneath and in contact with the ninth layer 150, but this latter condition is optional and it is contemplated that one or more intermediate sublayers [not shown] may be between the ninth layer 150 and the tenth layer 156. In the non-limiting aspect shown in FIG. 1, the tenth layer 156 comprises a standard twill weave translucent material. In the non-limiting aspect shown in FIG. 1, the tenth layer 156 is 0.15 mm thick. This latter recited thickness is optional and the thickness may deviate from that latter recited figure by 10%, by 20%, or by 40%. In the non-limiting aspect shown in FIG. 1, the tenth layer 156 has an average mass of 136 grams per square meter. This latter recited mass per square meter is optional and the mass per square meter may deviate from that latter recited figure by 10%, by 20%, or by 40%.

In the aspect shown in FIG. 1, the antibacterial composite 100 comprises an eleventh layer 162. The eleventh layer 162 is optional. In the non-limiting aspect shown, the eleventh layer 162 is directly beneath and in contact with the tenth layer 156, but this latter condition is optional and it is contemplated that one or more intermediate sublayers [not shown] may be between the tenth layer 156 and the eleventh layer 162. In the non-limiting aspect shown in FIG. 1, the eleventh layer 162 comprises a polypropylene film. In the non-limiting aspect shown in FIG. 1, the eleventh layer 162 is 0.02 mm thick. This latter recited thickness is optional and the thickness may deviate from that latter recited figure by 10%, by 20%, or by 40%. In the non-limiting aspect shown in FIG. 1, the eleventh layer 162 has an average mass of 18.4 grams per square meter. This latter recited mass per square meter is optional and the mass per square meter may deviate from that latter recited figure by 10%, by 20%, or by 40%.

In the aspect shown in FIG. 1, the antibacterial composite 100 comprises a twelfth layer 168. The twelfth layer 168 is optional. In the non-limiting aspect shown, the twelfth layer 168 is directly beneath and in contact with the eleventh layer 162, but this latter condition is optional and it is contemplated that one or more intermediate sublayers [not shown] may be between the eleventh layer 162 and the twelfth layer 168. In the non-limiting aspect shown in FIG. 1, the twelfth layer 168 comprises a standard twill weave translucent material. In the non-limiting aspect shown in FIG. 1, the twelfth layer 168 is 0.15 mm thick. This latter recited thickness is optional and the thickness may deviate from that latter recited figure by 10%, by 20%, or by 40%. In the non-limiting aspect shown in FIG. 1, the twelfth layer 168 has an average mass of 136 grams per square meter. This latter recited mass per square meter is optional and the mass per square meter may deviate from that latter recited figure by 10%, by 20%, or by 40%.

The antibacterial composite 100 was tested with test specification ISO 22196:2011-08 to provide a measurement of antibacterial activity on plastics as follows. A sample of antibacterial composite 100 was provided and was inoculated with a test strain of Staphylococcus aureus ATCC 6538P. A reference material was provided and was inoculated with a test strain of Staphylococcus aureus ATCC 6538P. The average number of active bacteria on the reference material at the time of inoculation was measured and reported as value A. The inoculated reference material and the inoculated sample of antibacterial composite 100 were both incubated for 24 hours. Upon the 24 hours elapsing, the average number of active bacteria on the reference material was measured and reported as value B. Upon the 24 hours elapsing, the average number of active bacteria on the sample of antibacterial composite 100 was measured and reported as value C. The specific antimicrobial activity S was calculated as follows: S=[Ig(B/A)−Ig(C/A)]=Ig (B/C). A was measured as 6.55×10\hat{ }5. B was measured to be 1.04×10\hat{ }4. C was measured to be less than 10. S was calculated as greater than or equal to 3.06. An S of 3 or greater indicates strong efficacy of the antibacterial property. The test showed the antibacterial composite 100 was strongly antibacterial with respect to Staphylococcus aureus ATCC 6538P.

Without wishing to be bound by any particular theory, it may be that the density of the top layer promotes the oligotrophic antibacterial action of the elemental silver or a silver compound or a mixture thereof with which the polypropylene film impregnated.

Referring now to FIG. 2, shown is one non-limiting aspect of an antiviral composite 200. In the aspect shown in FIG. 2, the antiviral composite 200 comprises a multitude of layers. In the aspect shown in FIG. 2, the antiviral composite 200 has a total thickness of 1.065 mm. This latter recited thickness is optional and the thickness may deviate from that latter recited figure by 10%, by 20%, or by 40%. In the aspect shown in FIG. 2, the antiviral composite 200 has an average mass of 968 grams per square meter. This latter recited mass per square meter is optional and the mass per square meter may deviate from that latter recited figure by 10%, by 20%, or by 40%.

In the aspect shown in FIG. 2, the antiviral composite 200 comprises a first layer 202. The first layer 202 is the top-most layer, and has a top surface 204 exposed to the environment 20. In this aspect, the first layer 202 comprises a non-woven polypropylene layer with elemental copper or a copper compound or a mixture thereof in or on the polypropylene layer. The elemental copper or a copper compound or a mixture thereof may optionally be impregnated or otherwise introduced to the polypropylene film by methods including vapor deposition. In some aspects, the copper is at least a 99% pure copper vaporized onto the nonwoven polypropylene layer. In some aspects the at least a 99% pure copper vaporized onto the nonwoven polypropylene layer is 99.5% pure copper or 99.9% pure copper. In some aspects, the nonwoven polypropylene layer is treated with plasma to promote good bonding. In the non-limiting aspect shown in FIG. 2, the polypropylene layer is 65 μm thick and the elemental copper or copper compound or mixture thereof is 50 μm thick. These latter recited thicknesses are optional. The thickness of the polypropylene layer may deviate from the recited figure of 65 μm by 10%, by 20%, or by 40%. The thickness of the the elemental copper or copper compound or mixture thereof may deviate from the recited figure of 50 μm by 10%, by 20%, or by 40%. In the non-limiting aspect shown in FIG. 2, the first layer 202 has an average mass of 60 grams per square meter. This latter recited mass per square meter is optional and the mass per square meter may deviate from that latter recited figure by 10%, by 20%, or by 40%.

In the aspect shown in FIG. 2, the antiviral composite 200 comprises a second layer 208. The second layer 208 is optional. In the non-limiting aspect shown, the second layer 208 is directly beneath and in contact with the first layer 202, but this latter condition is optional and it is contemplated that one or more intermediate sublayers [not shown] may be between the first layer 202 and the second layer 208. In the non-limiting aspect shown in FIG. 2, the second layer 208 comprises a standard twill weave translucent material. In the non-limiting aspect shown in FIG. 2, the second layer 208 is 0.15 mm thick. This latter recited thickness is optional and the thickness may deviate from that latter recited figure by 10%, by 20%, or by 40%. In the non-limiting aspect shown in FIG. 2, the second layer 208 has an average mass of 136 grams per square meter. This latter recited mass per square meter is optional and the mass per square meter may deviate from that latter recited figure by 10%, by 20%, or by 40%.

In the aspect shown in FIG. 2, the antiviral composite 200 comprises a third layer 214. The third layer 214 is optional. In the non-limiting aspect shown, the third layer 214 is directly beneath and in contact with the second layer 208, but this latter condition is optional and it is contemplated that one or more intermediate sublayers [not shown] may be between the second layer 208 and the third layer 214. In the non-limiting aspect shown in FIG. 2, the third layer 214 comprises a polypropylene film. In the non-limiting aspect shown in FIG. 2, the third layer 214 is 0.02 mm thick. This latter recited thickness is optional and the thickness may deviate from that latter recited figure by 10%, by 20%, or by 40%. In the non-limiting aspect shown in FIG. 2, the third layer 214 has an average mass of 18.4 grams per square meter. This latter recited mass per square meter is optional and the mass per square meter may deviate from that latter recited figure by 10%, by 20%, or by 40%.

In the aspect shown in FIG. 2, the antiviral composite 200 comprises a fourth layer 220. The fourth layer 220 is optional. In the non-limiting aspect shown, the fourth layer 220 is directly beneath and in contact with the third layer 214, but this latter condition is optional and it is contemplated that one or more intermediate sublayers [not shown] may be between the third layer 214 and the fourth layer 220. In the non-limiting aspect shown in FIG. 2, the fourth layer 220 comprises a standard twill weave translucent material. In the non-limiting aspect shown in FIG. 2, the fourth layer 220 is 0.15 mm thick. This latter recited thickness is optional and the thickness may deviate from that latter recited figure by 10%, by 20%, or by 40%. In the non-limiting aspect shown in FIG. 2, the fourth layer 220 has an average mass of 136 grams per square meter. This latter recited mass per square meter is optional and the mass per square meter may deviate from that latter recited figure by 10%, by 20%, or by 40%.

In the aspect shown in FIG. 2, the antiviral composite 200 comprises a fifth layer 226. The fifth layer 226 is optional. In the non-limiting aspect shown, the fifth layer 226 is directly beneath and in contact with the fourth layer 220, but this latter condition is optional and it is contemplated that one or more intermediate sublayers [not shown] may be between the fourth layer 220 and the fifth layer 226. In the non-limiting aspect shown in FIG. 2, the fifth layer 226 comprises a polypropylene film. In the non-limiting aspect shown in FIG. 2, the fifth layer 226 is 0.02 mm thick. This latter recited thickness is optional and the thickness may deviate from that latter recited figure by 10%, by 20%, or by 40%. In the non-limiting aspect shown in FIG. 2, the fifth layer 226 has an average mass of 18.4 grams per square meter. This latter recited mass per square meter is optional and the mass per square meter may deviate from that latter recited figure by 10%, by 20%, or by 40%.

In the aspect shown in FIG. 2, the antiviral composite 200 comprises a sixth layer 232. The sixth layer 232 is optional. In the non-limiting aspect shown, the sixth layer 232 is directly beneath and in contact with the fifth layer 226, but this latter condition is optional and it is contemplated that one or more intermediate sublayers [not shown] may be between the fifth layer 226 and the sixth layer 232. In the non-limiting aspect shown in FIG. 2, the sixth layer 232 comprises a standard twill weave translucent material. In the non-limiting aspect shown in FIG. 2, the sixth layer 232 is 0.15 mm thick. This latter recited thickness is optional and the thickness may deviate from that latter recited figure by 10%, by 20%, or by 40%. In the non-limiting aspect shown in FIG. 2, the sixth layer 232 has an average mass of 136 grams per square meter. This latter recited mass per square meter is optional and the mass per square meter may deviate from that latter recited figure by 10%, by 20%, or by 40%.

In the aspect shown in FIG. 2, the antiviral composite 200 comprises a seventh layer 238. The seventh layer 238 is optional. In the non-limiting aspect shown, the seventh layer 238 is directly beneath and in contact with the sixth layer 232, but this latter condition is optional and it is contemplated that one or more intermediate sublayers [not shown] may be between the sixth layer 232 and the seventh layer 238. In the non-limiting aspect shown in FIG. 2, the seventh layer 238 comprises a polypropylene film. In the non-limiting aspect shown in FIG. 2, the seventh layer 238 is 0.02 mm thick. This latter recited thickness is optional and the thickness may deviate from that latter recited figure by 10%, by 20%, or by 40%. In the non-limiting aspect shown in FIG. 2, the seventh layer 238 has an average mass of 18.4 grams per square meter. This latter recited mass per square meter is optional and the mass per square meter may deviate from that latter recited figure by 10%, by 20%, or by 40%.

In the aspect shown in FIG. 2, the antiviral composite 200 comprises an eighth layer 244. The eighth layer 244 is optional. In the non-limiting aspect shown, the eighth layer 244 is directly beneath and in contact with the seventh layer 238, but this latter condition is optional and it is contemplated that one or more intermediate sublayers [not shown] may be between the seventh layer 238 and the eighth layer 244. In the non-limiting aspect shown in FIG. 2, the eighth layer 244 comprises a standard twill weave translucent material. In the non-limiting aspect shown in FIG. 2, the eighth layer 244 is 0.15 mm thick. This latter recited thickness is optional and the thickness may deviate from that latter recited figure by 10%, by 20%, or by 40%. In the non-limiting aspect shown in FIG. 2, the eighth layer 244 has an average mass of 136 grams per square meter. This latter recited mass per square meter is optional and the mass per square meter may deviate from that latter recited figure by 10%, by 20%, or by 40%.

In the aspect shown in FIG. 2, the antiviral composite 200 comprises a ninth layer 250. The ninth layer 250 is optional. In the non-limiting aspect shown, the ninth layer 250 is directly beneath and in contact with the eighth layer 244, but this latter condition is optional and it is contemplated that one or more intermediate sublayers [not shown] may be between the eighth layer 244 and the ninth layer 250. In the non-limiting aspect shown in FIG. 2, the ninth layer 250 comprises a polypropylene film. In the non-limiting aspect shown in FIG. 2, the ninth layer 250 is 0.02 mm thick. This latter recited thickness is optional and the thickness may deviate from that latter recited figure by 10%, by 20%, or by 40%. In the non-limiting aspect shown in FIG. 2, the ninth layer 250 has an average mass of 18.4 grams per square meter. This latter recited mass per square meter is optional and the mass per square meter may deviate from that latter recited figure by 10%, by 20%, or by 40%.

In the aspect shown in FIG. 2, the antiviral composite 200 comprises a tenth layer 256. The tenth layer 256 is optional. In the non-limiting aspect shown, the tenth layer 256 is directly beneath and in contact with the ninth layer 250, but this latter condition is optional and it is contemplated that one or more intermediate sublayers [not shown] may be between the ninth layer 250 and the tenth layer 256. In the non-limiting aspect shown in FIG. 2, the tenth layer 256 comprises a standard twill weave translucent material. In the non-limiting aspect shown in FIG. 2, the tenth layer 256 is 0.15 mm thick. This latter recited thickness is optional and the thickness may deviate from that latter recited figure by 10%, by 20%, or by 40%. In the non-limiting aspect shown in FIG. 2, the tenth layer 256 has an average mass of 136 grams per square meter. This latter recited mass per square meter is optional and the mass per square meter may deviate from that latter recited figure by 10%, by 20%, or by 40%.

In the aspect shown in FIG. 2, the antiviral composite 200 comprises an eleventh layer 262. The eleventh layer 262 is optional. In the non-limiting aspect shown, the eleventh layer 262 is directly beneath and in contact with the tenth layer 256, but this latter condition is optional and it is contemplated that one or more intermediate sublayers [not shown] may be between the tenth layer 256 and the eleventh layer 262. In the non-limiting aspect shown in FIG. 2, the eleventh layer 262 comprises a polypropylene film. In the non-limiting aspect shown in FIG. 2, the eleventh layer 262 is 0.02 mm thick. This latter recited thickness is optional and the thickness may deviate from that latter recited figure by 10%, by 20%, or by 40%. In the non-limiting aspect shown in FIG. 2, the eleventh layer 262 has an average mass of 18.4 grams per square meter. This latter recited mass per square meter is optional and the mass per square meter may deviate from that latter recited figure by 10%, by 20%, or by 40%.

In the aspect shown in FIG. 2, the antiviral composite 200 comprises a twelfth layer 268. The twelfth layer 268 is optional. In the non-limiting aspect shown, the twelfth layer 268 is directly beneath and in contact with the eleventh layer 262, but this latter condition is optional and it is contemplated that one or more intermediate sublayers [not shown] may be between the eleventh layer 262 and the twelfth layer 268. In the non-limiting aspect shown in FIG. 2, the twelfth layer 268 comprises a standard twill weave translucent material. In the non-limiting aspect shown in FIG. 2, the twelfth layer 268 is 0.15 mm thick. This latter recited thickness is optional and the thickness may deviate from that latter recited figure by 10%, by 20%, or by 40%. In the non-limiting aspect shown in FIG. 2, the twelfth layer 268 has an average mass of 136 grams per square meter. This latter recited mass per square meter is optional and the mass per square meter may deviate from that latter recited figure by 10%, by 20%, or by 40%.

The antiviral composite 200 was tested with a test method developed following ISO 21702:2019-05 to provide a measurement of antiviral activity on plastics as follows. A sample of antibacterial composite 100 was provided and was treated with a test virus bacteriophage MS2 (DSM 13767, ATCC 15597-61). The host strain was Escherichia coli (DSM 5695, ATCC 12435). A reference material was provided and was treated with the same test virus and host strain. The treated reference material and the treated sample of antiviral composite 200 were both incubated for 24 hours. Upon the 24 hours elapsing, the average number of plaque forming units on the reference material was measured and reported as value R. Upon the 24 hours elapsing, the average number of plaque forming units on the sample of antiviral composite 200 was measured and reported as value P. The specific antiviral activity A* was calculated as follows: A*=Ig(R)−Ig(P). R was measured as 7.8×10\hat{ }7. P was measured to be 2.71×10\hat{ }2. A* was calculated as 5.46. An A* of 3 or greater indicates significant efficacy of the antiviral property. The test showed the antiviral composite 200 was significantly antiviral.

Without wishing to be bound by any particular theory, it may be that the density of the top layer promotes the oligotrophic antiviral action of the elemental copper or the copper compound or the mixture thereof with which the polypropylene film impregnated.

Although various examples of the disclosed antimicrobial composites 50 and associated methods of use have been shown and described, modifications may occur to those skilled in the art upon reading the specification. The present application includes such modifications and is limited only by the scope of the claims.

What is claimed is:

1. An antimicrobial composite comprising
a top layer
having a first polypropylene film impregnated with elemental silver or a silver compound or a mixture thereof,
the top layer having a thickness between 33 μm and 77 μm, and
the top layer having an average mass between 30.36 grams per square meter and 70.84 grams per square meter;
a second layer beneath and in contact with the top layer, the second layer
having a standard twill weave translucent material,
having a thickness between 0.09 mm and 0.21 mm, and
having an average mass of 81.6 grams per square meter and 190.4 grams per square meter;
a third layer beneath and in contact with the second layer, the third layer
having a second polypropylene film,
having a thickness between 0.012 mm and 0.028 mm, and
having an average mass of between 11.04 grams per square meter and 25.76 grams per square meter; and
wherein the antimicrobial composite has a specific antimicrobial activity with respect to Staphylococcus aureus ATCC 6538P of at least 3.

2. The antimicrobial composite of claim 1 further comprising a fourth layer beneath and in contact with the third layer, the fourth layer
having a standard twill weave translucent material,
having a thickness between 0.09 mm and 0.21 mm, and
having an average mass of 81.6 grams per square meter and 190.4 grams per square meter.

3. The antimicrobial composite of claim 2 further comprising a fifth layer beneath and in contact with the fourth layer, the fifth layer
having a third polypropylene film,
having a thickness between 0.012 mm and 0.028 mm, and
having an average mass of between 11.04 grams per square meter and 25.76 grams per square meter.

4. The antimicrobial composite of claim 3 further comprising a sixth layer beneath and in contact with the fifth layer, the sixth layer
having a standard twill weave translucent material,
having a thickness between 0.09 mm and 0.21 mm, and
having an average mass of 81.6 grams per square meter and 190.4 grams per square meter.

5. The antimicrobial composite of claim 4 further comprising a seventh layer beneath and in contact with the sixth layer, the seventh layer
having a fourth polypropylene film,
having a thickness between 0.012 mm and 0.028 mm, and
having an average mass of between 11.04 grams per square meter and 25.76 grams per square meter.

6. The antimicrobial composite of claim 5 further comprising an eighth layer beneath and in contact with the seventh layer, the eighth layer
having a standard twill weave translucent material,
having a thickness between 0.09 mm and 0.21 mm, and
having an average mass of 81.6 grams per square meter and 190.4 grams per square meter.

7. The antimicrobial composite of claim 6 further comprising a ninth layer beneath and in contact with the eighth layer, the ninth layer
having a fifth polypropylene film,
having a thickness between 0.012 mm and 0.028 mm, and
having an average mass of between 11.04 grams per square meter and 25.76 grams per square meter.

8. The antimicrobial composite of claim 7 further comprising a tenth layer beneath and in contact with the ninth layer, the tenth layer
having a standard twill weave translucent material,
having a thickness between 0.09 mm and 0.21 mm, and
having an average mass of 81.6 grams per square meter and 190.4 grams per square meter.

9. The antimicrobial composite of claim 8 further comprising an eleventh layer beneath and in contact with the tenth layer, the eleventh layer
having a sixth polypropylene film,
having a thickness between 0.012 mm and 0.028 mm, and
having an average mass of between 11.04 grams per square meter and 25.76 grams per square meter.

10. The antimicrobial composite of claim 9 further comprising a twelfth layer beneath and in contact with the eleventh layer, the twelfth layer
having a standard twill weave translucent material,
having a thickness between 0.09 mm and 0.21 mm, and
having an average mass of 81.6 grams per square meter and 190.4 grams per square meter.

11. An antimicrobial composite comprising
a top layer
having a first polypropylene film with a copper layer of elemental copper or a copper compound or a mixture thereof vapor deposited thereon,
the first polypropylene film having a thickness between 39 μm and 91 μm,
the copper layer having a thickness between 30 μm and 70 μm, and
the top layer having an average mass between 36 grams per square meter and 84 grams per square meter;
a second layer beneath and in contact with the top layer, the second layer
having a standard twill weave translucent material,
having a thickness between 0.09 mm and 0.21 mm, and
having an average mass of 81.6 grams per square meter and 190.4 grams per square meter;
a third layer beneath and in contact with the second layer, the third layer
having a second polypropylene film,
having a thickness between 0.012 mm and 0.028 mm, and
having an average mass of between 11.04 grams per square meter and 25.76 grams per square meter; and
wherein the antiviral composite has a specific antiviral activity with respect to bacteriophage MS2 of at least 5.4.

12. The antimicrobial composite of claim 11 further comprising a fourth layer beneath and in contact with the third layer, the fourth layer
having a standard twill weave translucent material,
having a thickness between 0.09 mm and 0.21 mm, and
having an average mass of 81.6 grams per square meter and 190.4 grams per square meter.

13. The antimicrobial composite of claim 12 further comprising a fifth layer beneath and in contact with the fourth layer, the fifth layer
having a third polypropylene film,
having a thickness between 0.012 mm and 0.028 mm, and
having an average mass of between 11.04 grams per square meter and 25.76 grams per square meter.

14. The antimicrobial composite of claim 13 further comprising a sixth layer beneath and in contact with the fifth layer, the sixth layer
having a standard twill weave translucent material,
having a thickness between 0.09 mm and 0.21 mm, and
having an average mass of 81.6 grams per square meter and 190.4 grams per square meter.

15. The antimicrobial composite of claim 14 further comprising a seventh layer beneath and in contact with the sixth layer, the seventh layer
having a fourth polypropylene film,
having a thickness between 0.012 mm and 0.028 mm, and
having an average mass of between 11.04 grams per square meter and 25.76 grams per square meter.

16. The antimicrobial composite of claim 15 further comprising an eighth layer beneath and in contact with the seventh layer, the eighth layer
having a standard twill weave translucent material,
having a thickness between 0.09 mm and 0.21 mm, and
having an average mass of 81.6 grams per square meter and 190.4 grams per square meter.

17. The antimicrobial composite of claim 16 further comprising a ninth layer beneath and in contact with the eighth layer, the ninth layer
having a fifth polypropylene film,
having a thickness between 0.012 mm and 0.028 mm, and
having an average mass of between 11.04 grams per square meter and 25.76 grams per square meter.

18. The antimicrobial composite of claim 17 further comprising a tenth layer beneath and in contact with the ninth layer, the tenth layer
having a standard twill weave translucent material,
having a thickness between 0.09 mm and 0.21 mm, and
having an average mass of 81.6 grams per square meter and 190.4 grams per square meter.

19. The antimicrobial composite of claim 18 further comprising an eleventh layer beneath and in contact with the tenth layer, the eleventh layer
having a sixth polypropylene film,
having a thickness between 0.012 mm and 0.028 mm, and
having an average mass of between 11.04 grams per square meter and 25.76 grams per square meter.

20. The antimicrobial composite of claim 9 further comprising a twelfth layer beneath and in contact with the eleventh layer, the twelfth layer
having a standard twill weave translucent material,
having a thickness between 0.09 mm and 0.21 mm, and
having an average mass of 81.6 grams per square meter and 190.4 grams per square meter.
